(19) United States
(12) Patent Application Publication
(10) Pub. No.: US 2011/0000260 A1
(43) Pub. Date: Jan. 6, 2011

(54) METHOD FOR PRODUCING AN OPTICAL GLASS PART, PARTICULARLY OF A MOTOR VEHICLE HEADLIGHT LENS

(75) Inventors: Jan Heiko Hamkens, Berlin (DE); Hubert Drexler, Amberg (DE)

Correspondence Address: BARNES & THORNBURG LLP, 11 SOUTH MERIDIAN, INDIANAPOLIS, IN, 46204, US

(73) Assignee: DOCTORS OPTICS GMBH, Neustafdt an der Orla (DE)

(21) Appl. No.: 12/920,230

(22) PCT Filed: Nov. 28, 2008
(86) PCT No.: PCT/EP08/10136

§ 371 Date: Aug. 30, 2010

(30) Foreign Application Priority Data
Mar. 3, 2008 (DE) 10 2008 012 283.1
Oct. 1, 2008 (DE) 10 2008 049 860.2

(51) Int. Cl. C03B 19/00

(52) U.S. Cl. 65/68

(57) ABSTRACT

The invention relates to a method for producing an optical glass part, particularly of a motor vehicle headlight lens or a lens-like free form for a motor vehicle headlight, wherein glass is melted, wherein a perform is formed from the glass, and wherein from the perform the motor vehicle headlight lens or the lens-like free form for a motor vehicle headlight is bright molded, particularly on both sides, wherein the glass is melted in a melting unit having a capacity of no more than 80 kg/h, wherein the glass comprised 0.2 to 2% weight Al₂O₃, 0 to 1% by weight Li₂O, 0.3 to 1.5% by weight Sb₂O₃, 0.3 to 2% weight TiO₂, and 0 to 1% by weight Er₂O₃.

### CROSS-REFERENCE TO RELATED APPLICATIONS

This application is the U.S. national phase of PCT/EP2008/010136 filed Nov. 28, 2008. PCT/EP2008/010136 claims the benefit under the Convention of German Patent Application No. 10 2008 012 283.1 filed Mar. 3, 2008 and German Patent Application No. 10 2008 049 860.2 filed Oct. 1, 2008.

### FIELD OF THE INVENTION

The invention relates to a method for producing an optical glass part, component or element, in particular a motor vehicle headlight lens or a lens-type shaped body or element for a vehicle headlight, wherein glass is melted, wherein a blank is moulded from the glass, and wherein the optical glass element, in particular the motor vehicle headlight lens or the lens-type shaped element for a motor vehicle headlight, is, in particular on both sides, blank-moulded from the blank.

### BACKGROUND INFORMATION

Methods for manufacturing motor vehicle headlight lenses are disclosed e.g. in WO 2007/095895, DE 103 23 989 B4, DE 196 33 164 C2, DE 10 2004 018 424 A1, DE 102 16 706 B4 and DE 10 2004 048 500 A1.

DE 103 23 989 B4 discloses a method for producing blank-moulded glass bodies for optical equipment, wherein a liquid (glass) batch is supplied to a levitation pre-mould into which the glass batch is pre-moulded into a blank without contacting the pre-mould, which blank is delivered to a separate pressing mould after a defined period of time has expired, and is pressed therein by means of a press-moulding tool into the final shape, wherein the transfer of the blank to the pressing mould occurs in such a way that the blank falls into the pressing mould from the pre-mould in free fall, wherein, for delivery of the glass batch, the pre-mould is moved over the pressing mould, is stopped in this transfer position and is pivoted away from the glass batch in a downward direction

DE 101 40 626 B4 discloses a method for producing a press-moulded glass body, in which melted liquid glass mass is poured into a mould, is pressed in the mould by means of a pressing die, and is cooled and subsequently removed from the mould as the press-moulded glass body, wherein the liquid melted glass mass is subjected to plural pressing operations within the mould, wherein cooling occurs between the pressing operations, and wherein, at least once, heating of the outer regions of the glass mass is performed between the pressing operations such that the cooling of the glass mass in the outer region is adapted to the cooling in the core.

DE 102 34 234 A1 discloses a method for blank-moulding a glass body for optical applications using a pressing mould comprising an upper mould and a lower mould and a ring, which pressing mould serves to receive the glass body heated to a temperature above its deformation temperature, in which method an electric potential is applied between the upper mould and the lower mould and a compression pressure is applied to the glass body at the latest after adapting the temperature of the glass body to the temperature of the pressing mould.

DE 103 48 947 A1 discloses a press for heat-moulding optical elements from glass with the aid of means for heating a form block comprising an upper mould, a lower mould and a guide ring, which form block receives the glass material, wherein inductive heating is provided as heating means and the form block is arranged on a thermally insulating body during said heating.

DE 196 33 164 C2 discloses a method and an apparatus for an at least one-sided blank-moulding of optical components serving illumination purposes, wherein, by means of a gripper, at least one mechanically portioned glass element is transferred to at least one annular receptacle adapted to be moved out from at least one furnace, and is moved into the furnace by the receptacle and heated therein on the receptacle, wherein the heated glass element is moved out of the furnace by the receptacle and is transferred back to the gripper which delivers the heated glass element to a press for at least one-sided blank-moulding, and wherein the blank-moulded glass element is then removed from the press, delivered to a cooling path and carried away from the same.

DE 103 60 259 A1 discloses a method for blank-moulding optical elements from glass, in which method a glass batch arranged in a mould block is heated to a temperature T above its transformation temperature T_{G}, the glass batch is pressed and cooled to a temperature below T_{G}, wherein the cooling is initially performed in a first temperature interval lying above T_{G} at a first cooling rate and subsequently, in a second temperature interval which includes T_{G} at a second cooling rate, and wherein active cooling is performed for adjusting the first and second cooling rates.

DE 44 22 053 C2 discloses a method for manufacturing glass blanks, in which method melted liquid glass is pressed into a pressing mould defining its outer shape, in a pressing station by means of a pressing die defining the inner shape of the glass blank, wherein the pressing die remains in contact with the glass blank in the pressing mould only as long after the pressing step, and with heat being lead away from the surface of the glass blank, until the glass blank has cooled down in its region close to the surface to such a temperature that it will have obtained sufficient structural stability of its surface for being removed from the pressing mould, and wherein the glass blank is subsequently taken out of the pressing mould and transferred to a cooling station, before it becomes deformed due to partial heating, and the glass blank is cooled in the cooling station until it has completely solidified.

FIG. 7 shows a principal representation of a typical motor vehicle headlight 61 having a light source 70 for generating light, a reflector 72 for reflecting light being generated by means of the light source 70, and a shield 74. The motor vehicle headlight 61, moreover, comprises a headlight lens 62 for changing the (light) beam direction of light to be generated by the light source 70, and for imaging an edge 75 of the shield 74 as a light-dark-border 95.

The headlight lens 62 comprises a lens body 63 made of glass, which body includes an essentially planar surface 75 facing the light source 70, and an essentially convex surface 64 facing away from the light source 70. The headlight lens 62 furthermore comprises a brim 66 by means of which the headlight lens 62 can be attached within the vehicle headlight 61. Headlight lenses for motor vehicle headlights are subjected to rather narrow design criteria with respect to their optical properties or their recommended light-technical values. This, in particular, applies with respect to the light-dark-borderline 95 as has been represented by way of example in FIG. 10 in a diagram 90 and by way of a photograph 91. In this respect, important light-technical guideline values are considered to be the gradient G of the light-dark-borderline 95 and the glare value HV of the vehicle headlight into which the headlight lens will be installed. It is a particular challenge to meet these narrow criteria of design with the aim of achieving a cost-efficient mass production of headlight lenses for motor vehicle headlights.

It is an object of the invention to reduce the costs for manufacturing optical glass elements. It is, in particular, an object of the invention to reduce the costs for manufacturing headlight lenses for motor vehicle headlights. It is a further object of the invention to produce a particularly high-quality headlight lens for a motor vehicle headlight within a restricted budget with, in particular, light-technical requirements having to be met with respect to gradient and glare value.

### SUMMARY

The aforementioned objects are achieved by a method for producing an optical glass element, in particular a motor vehicle headlight lens or a lens-type shaped body for a motor vehicle headlight, wherein glass is melted in a melting aggregate having a capacity of not more than 80 kg/h, wherein the glass comprises
0.2 to 2% by weight Al₂O_{3,}
0.1 to 1% by weight Li₂O_{,}
0.3 (in particular 0.4) to 1.5% by weight Sb₂O_{3,}
0.3 to 2% by weight TiO₂, and/or
0.01 (in particular 0.1) to 1 (in particular 0.3) % by weight Er₂O_{3,}
   wherein a blank is moulded from the glass, and wherein the optical glass element, in particular the motor vehicle headlight lens or the lens-type shaped element for a motor vehicle headlight is blank-moulded, in particular on both-sides. By “capacity”, the average or mean capacity relating to one day is to be understood.

In the sense of the invention, an optical glass element serves for a specific, purposeful alignment of light, in particular for illuminating or imaging purposes. In the sense of the invention, an optical glass element serves the specific alignment of light for technical purposes, which optical glass element, in particular, has to be distinguished from purely aesthetical glass elements. In a particularly advantageous manner, an optical glass element, in the sense of the invention, is a motor vehicle headlight lens or a lens-type shaped body for a motor vehicle lens. An optical glass element, in the sense of the invention, specifically consists of (essentially) inorganic glass. In particular, an optical glass element, in the sense of the invention, (essentially) consists of silicate glass. An optical glass element, in the sense of the invention, is, in particular, a lens and/or a prism. An optical glass element, in the sense of the invention, may comprise one or several optical structures for a purposeful alignment of light. An optical glass element, in the sense of the invention, is, in particular, a precision lens. A precision lens, in the sense of the invention, is, in particular, a lens the contour of which differs by no more than 8 μm, in particular by no more than 2 μm, from the desired nominal value, and/or the surface roughness of which amounts to no more than 5 nm. In the sense of the invention, surface roughness is to be defined, in particular, as Ra, specifically according to ISO 4287. A precision lens, in the sense of the invention, is, in particular, a lens the contour of which differs by no more than 1 μm (lens diameter/10 mm) from a desired nominal contour. An optical glass element, in the sense of the invention, may be a concentrator for sunlight as well as an array having several concentrators.

In an embodiment of the invention the glass comprises
60 to 75% by weight SiO_{2,}
3 to 12% by weight Na₂O_{,}
0.3 to 2% by weight BaO_{,}
3 to 12% by weight K₂O_{,} and/or
3 to 12% by weight CaO.

In a further embodiment of the invention the glass comprises
0 to 5% by weight MgO_{,}
0 to 2% by weight SrO, and
0 to 3% by weight B₂O₃.

In a further embodiment of the invention the glass comprises 0.5 to 6% by weight ZnO.

In a further embodiment of the invention the glass comprises
0.3 to 0.8 (in particular to 1.4) % by weight Al₂O_{3,}
0.1 to 0.4% by weight Li₂O_{,}
0.1 (in particular 0.3) to 2% by weight BaO, and/or
0.01 to 0.3% by weight Er₂O₃.

In a further embodiment of the invention the glass comprises
0 (in particular 0.1) to 2 ppm CoO_{,}
0 to 0.1% by weight Cr₂O_{3,}
0 (in particular 0.1) to 0.2% by weight Pr₆O_{11,}
0 (in particular 0.1) to 1.5% by weight MnO_{,}
0 to 0.1% by weight NiO, and/or
   0 (in particular 0.1) to 0.2% by weight Nd₂O₃.

In a further expedient embodiment of the invention the glass is melted in the melting aggregate from a conglomerate or (glass) batch. In a further embodiment of the invention the glass is melted in the melting aggregate at a temperature of no more than 1500° C. In a further expedient embodiment of the invention the glass is melted in the melting aggregate at a temperature of not less than 1000° C. In a further embodiment of the invention a batch carpet having a thickness of between 2 cm and 7 cm is maintained on the glass melted in the melting aggregate.

In a further embodiment of the invention the temperature gradient of the blank is reversed, wherein the blank is expediently (for reversing the temperature gradient) moved (in particular essentially continuously), lying on a cooled lance, through a tempering device (for cooling and/or heating the blank), or is held in a tempering device. An appropriate, cooled lance has been disclosed in DE 101 00 515 A1. In a further embodiment of the invention, the lance is passed by cooling medium according to the principle of counter-flow. In a further embodiment of the invention the cooling medium is heated additionally and actively, respectively.

In a further embodiment of the invention the temperature gradient of the blank is adjusted such that the temperature of the core of the blank lies above room temperature by at least 100° C. In a further embodiment of the invention the blank, for reversing its temperature gradient, is, in first place, cooled, in particular by adding heat, and subsequently it is heated, wherein there is in particular provided that the blank is heated such that the temperature of the surface of the blank, after the heating, is higher than the transformation temperature T_{G} of the glass by at least 100° C., in particular by at least 150° C. The transformation temperature T_{G} of the glass is the temperature at which the glass becomes hardened. In the sense of the invention, the transformation temperature T_{G} is to be, in particular, the temperature of the glass at which this has a viscosity log in a region of about 13.2 (corresponding to 10^{13.2} Pa·s), in particular between 13 (corresponding to 10¹³ Pa·s) and 14.5 (corresponding to 10^{14.5} Pa·s).

In a further embodiment of the invention the blank is cooled at a temperature of between 300° C. and 500° C., in particular of between 350° C. and 450° C. In a further embodiment of the invention the blank is cooled at a temperature of between 20K and 200K, in particular between 70K and 150K, below the transformation temperature T_{G} of the glass of the blank. In a further embodiment of the invention the blank is heated at a temperature of between 1000° C. and 1250° C.

In a further embodiment of the invention the gradient of the viscosity of the blank before pressing is at least 10⁴ Pa·s, in particular at least 10⁵ Pa·s. It should be noted that by the term gradient of the viscosity of the blank, in particular the difference between the viscosity of the core of the blank and the viscosity of the surface of the blank is to be understood.

In a further embodiment of the invention the mass of the blank amounts to (approximately) 50 g to 250 g.

In the sense of the invention, a motor vehicle is, in particular, a land vehicle to be used individually in road traffic. In the sense of the invention, motor vehicles are, in particular, not restricted to land vehicles having a combustion engine.

Advantages and details of the invention may be taken from the following description of examples of embodiment.

### BRIEF DESCRIPTION OF THE DRAWINGS

FIG. 1 shows a schematic representation of an apparatus for producing a motor vehicle headlight lens or a lens-type shaped element for a motor vehicle headlight;

FIG. 2 shows an exemplary course of a method for producing a motor vehicle headlight lens or a lens-type shaped element for a motor vehicle headlight;

FIG. 3 shows an example of embodiment of a melting aggregate represented by way of a schematic view;

FIG. 4 shows an exemplary blank before entering into a tempering device;

FIG. 5 shows an exemplary blank having a reversed temperature gradient after leaving a tempering device;

FIG. 6 shows an apparatus for pressing a headlight lens;

FIG. 7 shows a schematic representation of a typical motor vehicle headlight lens;

FIG. 8 shows an example of embodiment of a lens-type shaped element for a motor vehicle headlight;

FIG. 9 shows a further example of embodiment of a lens-type shaped element for a motor vehicle headlight; and

FIG. 10 shows the distribution of illumination by a headlight.

### DETAILED DESCRIPTION

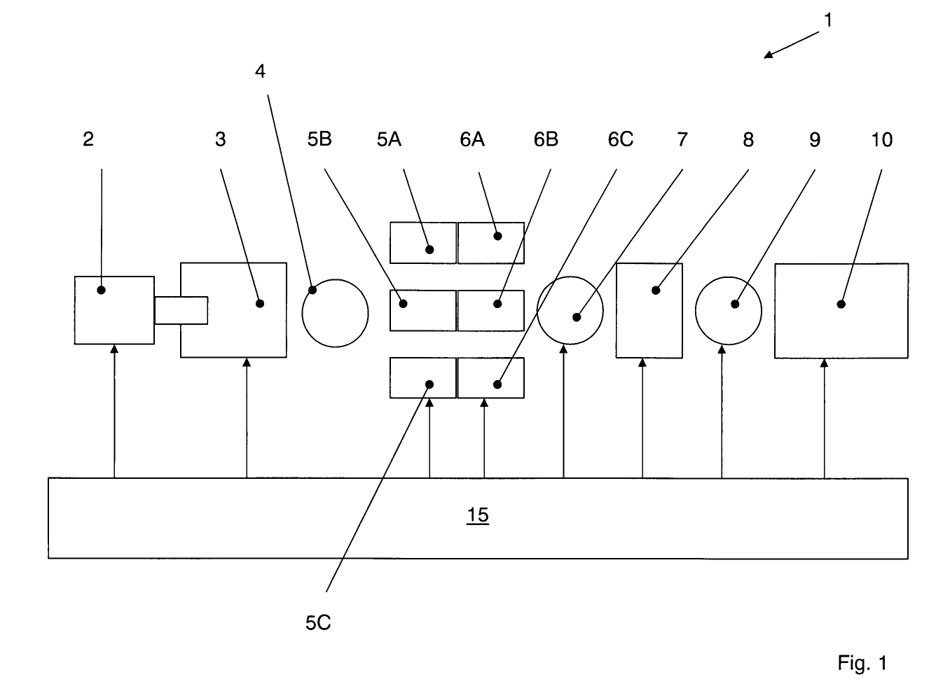

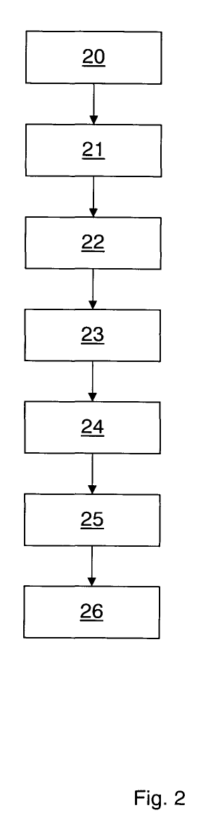

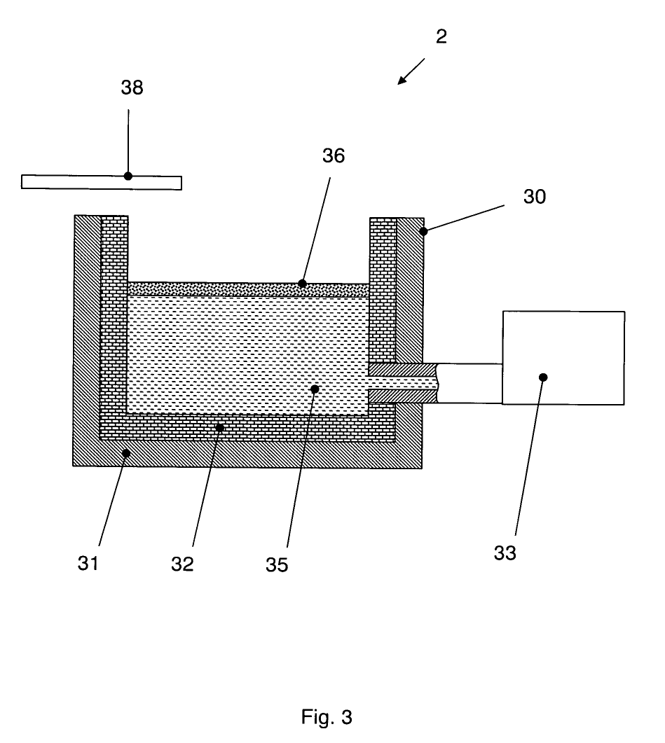

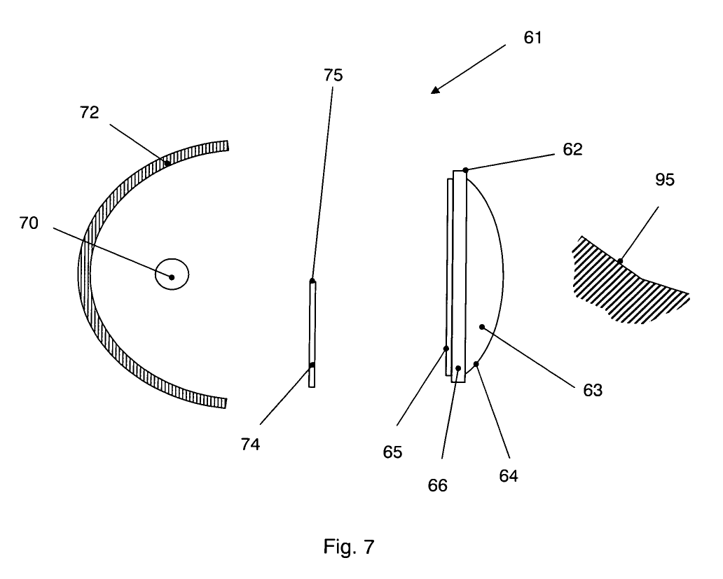

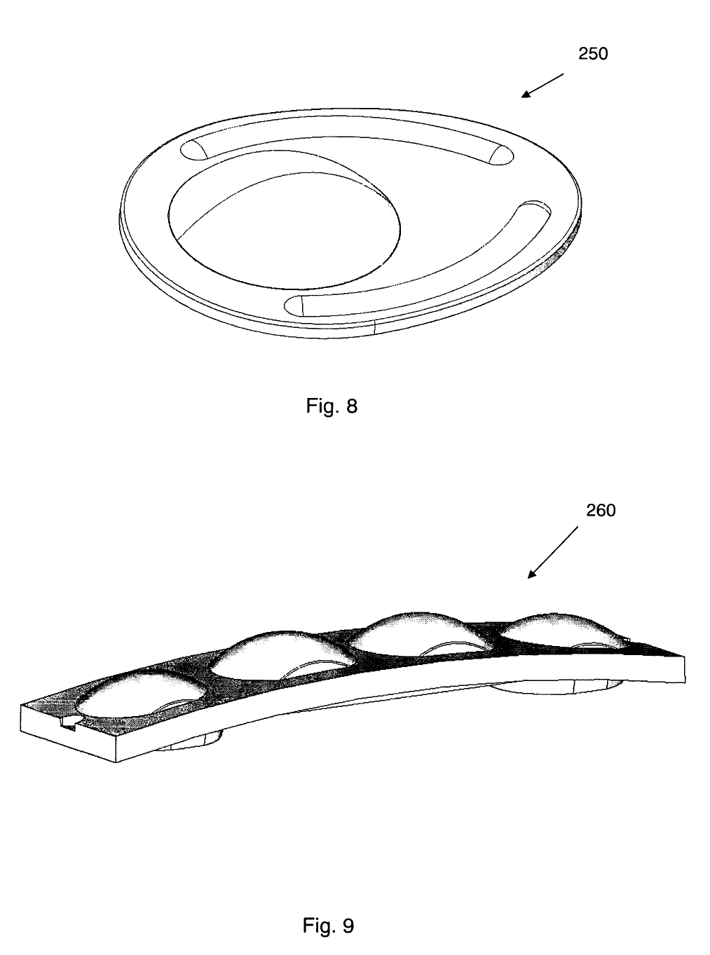

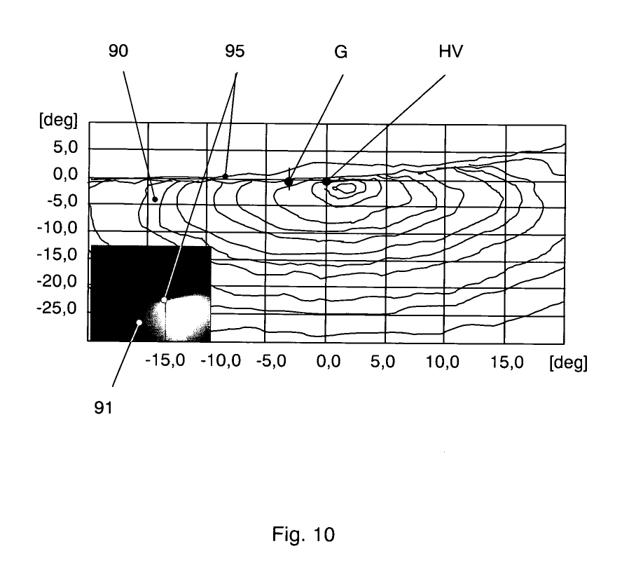

FIG. 1 shows an apparatus 1 (shown by way of a principle representation) for performing a process, as represented in FIG. 2, for producing motor vehicle headlight lenses, such as the motor vehicle headlight lens 62 as represented in FIG. 7, or of lens-type shaped elements for motor vehicle headlights as, for example, the lens-type shaped elements 250 and 260 for motor vehicle headlights such as represented in FIG. 8 and FIG. 9. The apparatus 1 comprises a melting aggregate 2 shown in detail in FIG. 3 and having a capacity of no more than 80 kg/h, in which aggregate glass is melted in a procedural step 20. The glass comprises
60 to 75% by weight SiO₂,
3 to 12% by weight Na₂O,
3 to 12% by weight K₂O,
3 bis 12% by weight CaO,
0.2 to 2% by weight Al₂O₃, in particular 0.3 to 1.4% by weight Al₂O₃,
0 to 1% by weight Li₂O, in particular 0 to 0.5% by weight Li₂O,
0 to 5% by weight MgO,
0 to 2% by weight SrO,
0.5 to 6% by weight ZnO,
0 to 3% by weight B₂O₃, in particular 0 to 2% by weight B₂O₃,
0 to 2% by weight TiO₂, in particular 0.3 to 2% by weight TiO₂,
0.3 to 2% by weight BaO,
0.3 to 1.5% by weight Sb₂O₃ in particular 0.4 to 1.2% by weight Sb₂O₃,
0 to 1% by weight Er₂O₃, in particular 0 to 0.3% by weight Er₂O₃, particularly 0 to 0.2% by weight Er₂O₃
0 to 2 ppm CoO,
0 to 0.1% by weight Cr₂O₃,
0 to 0.2% by weight Pr₆O₁₁,
0 to 0.2% by weight NiO,
0 to 0.2% by weight Nd₂O₃.

In particular there is provided that the glass comprises no more than 0.3, in particular no more than 0.2% by weight Er₂O₃.

Furthermore, the glass comprises no (i.e. in particular no more than 0.1% by weight) Fe₂O₃, ZrO₂, Nb₂O₅, Ta₂O₅, and F. Furthermore, the glass preferably comprises no, in particular no more than 0.2% by weight NiO. Furthermore, the glass preferably comprises no, in particular no more than 0.05% by weight Se. Furthermore, the glass preferably comprises no, in particular no more than 2% by weight MnO₂.

Table 1 shows a particularly appropriate glass composition:

TABLE 1

| Component | Target value (% by weight) |
|---|---|
| SiO₂ | 68.00 |
| Al₂O₃ | 0.70 |
| Fe₂O₃ | 0.010 |
| CaO | 3.98 |
| MgO | 2.80 |
| BaO | 1.15 |
| K₂O | 8.68 |
| Na₂O | 8.79 |
| TiO₂ | 0.95 |
| Sb₂O₃ | 0.62 |
| ZnO | 3.33 |
| B₂O₃ | 1.00 |

It has, in particular, been provided that the Fe₂O₃ content of the glass amounts to below 0.015% by weight and that traces of (<0.01% by weight) Er₂O₃ and/or other metal oxides of rare earths and/or transition metal oxides are applied for decolouring glass.

The melting aggregate 2, which has been represented in detail in FIG. 3 by way of a schematic view, comprises a melting vat 30 having a support structure 31 and a fire-resistant lining 32. By means of the melting vat 30, glass 35 is melted from a batch delivered by means of a batch feeder 38 with non-shown electrodes being provided for applying energy. The batch feeder 38 is controlled, adjusted and/or varied such that a batch carpet 36 having a thickness of between 2 cm and 7 cm is formed on the molten glass 35. The melting aggregate 2, moreover, comprises an outlet 33 which, for example, can be controlled/varied.

In a procedural step 21, liquid glass is passed from the melting aggregate 2 into a pre-moulding apparatus 3 for producing a blank having, in particular, a mass of 50 g up to 250 g, such as, for example, a gob or a blank having a shape which is close to the final shape (a blank with a shape close to the final shape has a contour which is similar to the contour of the motor vehicle headlight lens or the lens-type shaped element for motor vehicle headlights to be pressed). Such pre-moulding apparatus may, for example, include moulds into which a defined amount of glass is poured. The blank is produced by means of the pre-moulding apparatus 3 in a procedural step 22.

The procedural step 22 is followed by a procedural step 23 in which the blank is passed, by means of a transfer station 4, to one of the cooling devices 5A, 5B, or 5C, and is cooled by means of the cooling devices 5A, 5B, or 5C at a temperature of between 300° C. and 500° C. In a subsequent procedural step 24 the blank is heated, by means of one of the heating devices 6A, 6B, or 6C, at a temperature of between 1000° C. and 1250° C., wherein it has in particular been provided that the blank is heated such that the temperature of the surface of the blank is higher than T_{G}, by at least 100° C., in particular at least 150° C. An example for a tempering device for setting the temperature gradient in the sense of the claims is reflected by a combination of the cooling device 5A and the heating device 6A, by a combination of the cooling device 5B and the heating device 6B, and by a combination of the cooling device 5C with the heating device 6C, respectively.

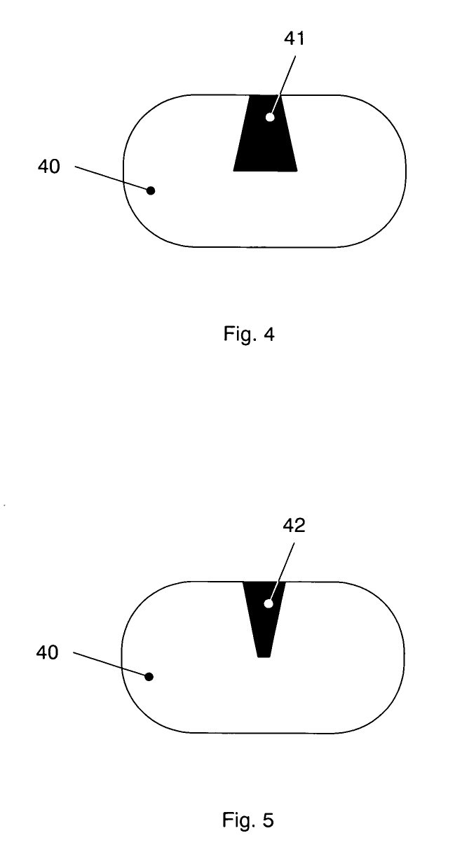

The procedural steps 23 and 24 are, as will be explained in the following with reference to FIG. 4 and FIG. 5, made to match each other such that a reversing of the temperature gradient is achieved. In this context, FIG. 4 shows an exemplary blank 40 before entering one of the cooling devices 5A, 5B, or 5C, and FIG. 5 shows the blank 40 having a reversed temperature gradient after leaving one of the heating devices 6A, 6B, or 6C. While the blank is warmer in its interior than on the outside before procedural step 23 (supposing there is a continuous temperature profile), the blank, following procedural step 24, will be warmer on the outside than in its interior, also in the case of a continuous temperature profile. The wedges designated by reference numerals 41 and 42 symbolize the temperature gradients with the width of each wedge 41 and 42, respectively, symbolizing the temperature.

For reversing its temperature gradient, in an embodiment, a blank is moved, lying on a non-shown cooled lance (in a particularly essentially continuous manner) through a tempering device including one of the cooling devices 5A, 5B, or 5C and one of the heating devices 6A, 6B, or 6C, or it is maintained in one of the cooling devices 5A, 5B, or 5C and/or one of the heating devices 6A, 6B, or 6C. An appropriate, cooled lance has been disclosed in DE 101 00 515 A1. Cooling medium flows through the lance, in particular according to the principle of counter-flow. Alternatively or additionally there may be provided that the cooling medium be heated additionally and actively, respectively.

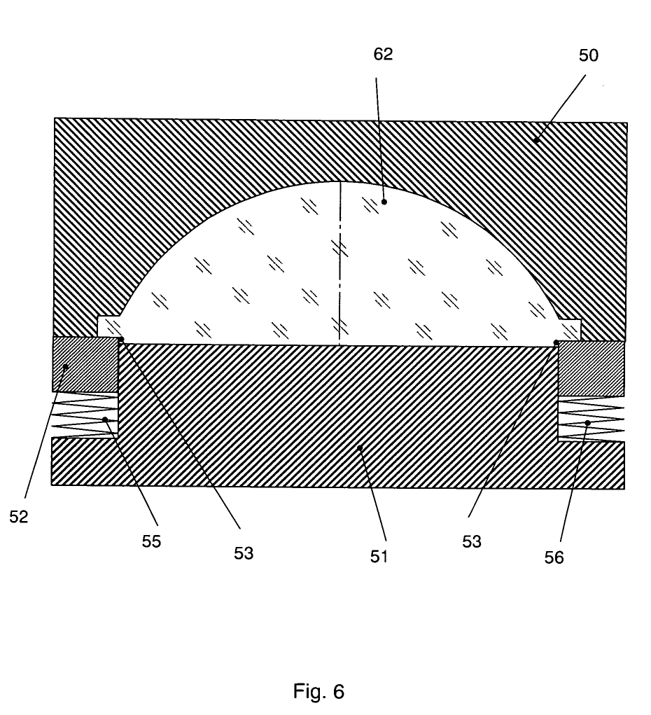

A procedural step 25 follows, in which the blank 40 is blank-moulded, by means of an apparatus represented in FIG. 6, which forms a part of the press 8, between a first mould 50 and a second mould, which comprises a first partial mould 51 and a second partial mould 52 which is of annular shape and surrounds the first partial mould 51, into a motor vehicle headlight lens 62 or a lens-type shaped element for a motor vehicle headlight having an integrally moulded lens border or brim 66, wherein, by means of an offset 53 provided between the first partial mould 51 and the second partial mould 52 and depending on the volume of the blank 40, a step is pressed into the motor vehicle headlight lens 62 or the lens-type shaped element for motor vehicle headlights. Herein, pressing particularly occurs neither in a vacuum nor under significant low pressure. In particular, pressing occurs in atmospheric air pressure. The first partial mould 51 and the second partial mould 52 are coupled with each other non-positively by means of springs 55 and 56. In this context, the pressing occurs such that the distance between the first partial mould 51 and the first mould 50 is dependent on the volume of the blank 40 or the headlight lens 62 or lens-type shaped element for motor vehicle headlights pressed from the blank, respectively, and that the distance between the second partial mould 52 and the first mould 50 is independent of the volume of the blank 40 and the headlight lens 62 or the lens-type shaped element for motor vehicle headlights pressed from the blank, respectively.

Subsequently the motor vehicle headlight lens 62 or the lens-type shaped element for motor vehicle headlights is transferred to a cooling path 10 by means of a transfer station 9. The motor vehicle headlight lens or the lens-type shaped element for motor vehicle headlights is cooled in a procedural step 26 by means of the cooling path 10. Moreover, the apparatus 10 represented in FIG. 1 comprises a computing device 15 for controlling or varying the apparatus 1 shown in FIG. 1. The computing device 15 in particular provides a continuous linking of the individual procedural steps.

The elements shown in FIG. 1, FIG. 3, FIG. 4, FIG. 5, FIG. 6, and FIG. 7 have not necessarily been drawn to scale for the reason of consideration of simplicity and clearness. Thus, for example the orders of dimension of some elements have been exaggerated with respect to other elements in order to enhance the comprehension of the examples of embodiment of the present invention.

The process for producing motor vehicle headlight lenses having been described with reference to FIG. 1, FIG. 3, FIG. 4, FIG. 5, and FIG. 6 may also well be applied for producing other optical glass elements in an analogous manner. However, it should be noted that the process is, in a very particular way, appropriate for a cost-effective, economic production of high-grade motor vehicle headlight lenses.

1-20. (canceled)

21. Method for producing an optical glass element; the method comprising:
melting glass in a melting aggregate having a capacity of not more than 80 kg/h, wherein the glass comprises at least one of the group consisting of
0.2 to 2% by weight Al₂O_{3,}
0.1 to 1% by weight Li₂O_{,}
0.3 to 1.5% by weight Sb₂O_{3,}
0.3 to 2% by weight TiO_{2,} and
0.01 to 1% by weight Er₂O₃;
moulding a blank is from the glass; and
blank-moulding one of the group consisting of (a) optical glass element, (b) motor vehicle headlight lens and (c) lens-type shaped body for a motor vehicle headlight from the blank.

22. Method according to claim 21, wherein the glass comprises
60 to 75% by weight SiO_{2,}
3 to 12% by weight Na₂O_{,}
3 to 12% by weight K₂O_{,} and
3 to 12% by weight CaO.

23. Method according to claim 22, wherein the glass comprises
0 to 5% by weight MgO_{,}
0 to 2% by weight SrO, and
0 to 3% by weight B₂O₃.

24. Method according to claim 21, wherein the glass comprises
0 to 5% by weight MgO_{,}
0 to 2% by weight SrO, and
0 to 3% by weight B₂O₃.

25. Method according to claim 23, wherein the glass comprises 0.5 to 6% by weight ZnO.

26. Method according to claim 21, wherein the glass comprises 0.5 to 6% by weight ZnO.

27. Method according to claim 21, wherein the glass comprises 0.3 to 0.8% by weight Al₂O₃.

28. Method according to claim 21, wherein the glass comprises 0.3 to 1.4% by weight Al₂O₃.

29. Method according to claim 21, wherein the glass comprises 0.3 to 2% by weight BaO.

30. Method according to claim 22, wherein the glass comprises 0.3 to 0.8% by weight Al₂O₃.

31. Method according to claim 22, wherein the glass comprises 0.3 to 1.4% by weight Al₂O₃.

32. Method according to claim 22, wherein the glass comprises 0.3 to 2% by weight BaO.

33. Method according to claim 21, wherein the glass comprises 0.1 to 0.4% by weight Li₂O.

34. Method according to claim 21, wherein the glass comprises 0.01 to 0.3% by weight Er₂O₃.

35. Method according to claim 21, wherein the glass is melted from a batch in the melting aggregate.

36. Method according to claim 22, wherein the glass is melted from a batch in the melting aggregate.

37. Method according to claim 21, wherein the glass is melted in the melting aggregate at a temperature of not more than 1500° C.

38. Method according to claim 22, wherein the glass is melted in the melting aggregate at a temperature of not more than 1500° C.

39. Method according to claim 21, wherein glass is melted in the melting aggregate at a temperature of not less than 1000° C.

40. Method according to claim 22, wherein glass is melted in the melting aggregate at a temperature of not less than 1000° C.

41. Method according to claim 21, the method further comprising:
maintaining a batch carpet having a thickness of between 2 cm and 7 cm on the molten the glass in the melting aggregate.

42. Method according to claim 22, the method further comprising:
maintaining a batch carpet having a thickness of between 2 cm and 7 cm on the molten the glass in the melting aggregate.

43. Method according to claim 22, the method further comprising:
reversing the temperature gradient in the blank.

44. Method according to claim 21, the method further comprising:
reversing the temperature gradient in the blank.

45. Method according to claim 44, wherein the blank, for reversing its temperature gradient, is moved lying on a cooled lance through a tempering device.

46. Method according to claim 44, wherein the blank, for reversing its temperature gradient, is held in a tempering device.

47. Method according to claim 44, wherein a gradient of the viscosity of the blank before blank-moulding is at least 10⁴ Pa·s.

48. Method according to claim 21, wherein a gradient of the viscosity of the blank before blank-moulding is at least 10⁴ Pa·s.

49. Method according to claim 21, wherein a gradient of the viscosity of the blank before blank-moulding is at least 10⁵ Pa·s.

50. Method according to claim 21, wherein the mass of the blank amounts to 50 g to 250 g.

51. Method for producing an optical glass element; the method comprising:
melting glass in a melting aggregate having a capacity of not more than 80 kg/h, wherein the glass comprises
0.2 to 2% by weight Al₂O_{3,}
0.3 to 1.5% by weight Sb₂O_{3,}
0.3 to 2% by weight TiO_{2,}
60 to 75% by weight SiO_{2,}
3 to 12% by weight Na₂O_{,}
3 to 12% by weight K₂O_{,}
3 to 12% by weight CaO,
0 to 5% by weight MgO_{,}
0 to 3% by weight B₂O₃,
0.5 to 6% by weight ZnO and
0.3 to 2% by weight BaO;
moulding a blank is from the glass; and
blank-moulding one of the group consisting of (a) optical glass element, (b) motor vehicle headlight lens and (c) lens-type shaped body for a motor vehicle headlight from the blank.

52. Method according to claim 51, wherein the glass comprises 0.5 to 5% by weight MgO.

53. Method according to claim 51, wherein the glass comprises 0.3 to 3% by weight B₂O₃.

54. Method according to claim 52, wherein the glass comprises 0.3 to 3% by weight B₂O₃.

55. Method according to claim 51, wherein the glass comprises less than 0.015% by weight Fe₂O₃.

56. Method according to claim 52, wherein the glass comprises less than 0.015% by weight Fe₂O₃.

57. Method according to claim 53, wherein the glass comprises less than 0.015% by weight Fe₂O₃.

58. Method for producing an optical glass element; the method comprising:
melting glass in a melting aggregate having a capacity of not more than 80 kg/h, wherein the glass comprises 0.2 to 2% by weight Al₂O_{3,} 60 to 75% by weight SiO_{2,} 3 to 12% by weight Na₂O_{,} 3 to 12% by weight K₂O_{,} and 3 to 12% by weight CaO, and wherein the glass comprises less than 0.015% by weight Fe₂O₃;
moulding a blank is from the glass; and
blank-moulding one of the group consisting of (a) optical glass element, (b) motor vehicle headlight lens and (c) lens-type shaped body for a motor vehicle headlight from the blank.

59. Method according to claim 58, wherein the glass comprises
0 to 5% by weight MgO_{,}
0 to 2% by weight SrO, and
0 to 3% by weight B₂O₃.

60. Method according to claim 58, wherein the glass comprises 0.3 to 1.4% by weight Al₂O₃.

61. Method according to claim 58, wherein the glass comprises 0.3 to 2% by weight BaO.

62. Method according to claim 58, wherein the glass comprises 0.1 to 0.4% by weight Li₂O.

63. Method according to claim 58, wherein the glass comprises 0.01 to 0.3% by weight Er₂O₃.

64. Method according to claim 58, wherein the glass is melted from a batch in the melting aggregate.

65. Method according to claim 58, wherein the glass is melted in the melting aggregate at a temperature of not more than 1500° C.

66. Method according to claim 58, wherein glass is melted in the melting aggregate at a temperature of not less than 1000° C.

67. Method according to claim 58, the method further comprising:
maintaining a batch carpet having a thickness of between 2 cm and 7 cm on the molten the glass in the melting aggregate.

68. Method according to claim 58, wherein the mass of the blank amounts to 50 g to 250 g.
